(19) United States
(12) Patent Application Publication
(10) Pub. No.: US 2026/0173238 A1
(43) Pub. Date: Jun. 18, 2026

(54) INFORMATION PROCESSING APPARATUS, LIVING BODY DETECTION SYSTEM, AND INFORMATION PROCESSING METHOD

(71) Applicant: Mitsubishi Electric Corporation, Tokyo (JP)

(72) Inventors: Takayuki KITAMURA, Tokyo (JP); Isao MATSUSHIMA, Tokyo (JP); Satoshi KAGEME, Tokyo (JP); Tadashi OSHIMA, Tokyo (JP)

(73) Assignee: Mitsubishi Electric Corporation, Tokyo (JP)

(21) Appl. No.: 19/530,578

(22) Filed: Feb. 5, 2026

Related U.S. Application Data
(63) Continuation of application No. PCT/JP2023/032769, filed on Sep. 8, 2023.

(51) Int. Cl. H05B 47/115; G01S 13/08

(52) U.S. Cl. CPC H05B 47/115; G01S 13/08

(57) ABSTRACT

An information processing apparatus includes: an information acquisition unit to acquire first distance information about a distance from a first antenna to a living body and second distance information about a distance from a second antenna to the living body, the first antenna and the second antenna being arranged at mutually different positions, the first distance information and the second distance information being obtained by receiving reflection waves of electromagnetic waves, transmitted from the first antenna and the second antenna, off the living body at the first antenna and the second antenna; and an estimation unit to reproduce a synthetic aperture image of an observation space on the basis of the first distance information, the second distance information, and positional information about each of the first antenna and the second antenna, and estimate a position of the living body on the basis of the synthetic aperture image.

### CROSS REFERENCE TO RELATED APPLICATION

This application is a Continuation of PCT International Application No. PCT/JP 2023/032769, filed on Sep. 8, 2023, which is hereby expressly incorporated by reference into the present application.

### TECHNICAL FIELD

The present disclosure relates to an information processing apparatus, a living body detection system, and an information processing method.

### BACKGROUND ART

Conventionally, there has been a disclosed system in which moving objects such as humans are sensed using a plurality of radar detectors incorporated into illumination units of streetlight poles (see Patent Literature 1).

### CITATION LIST

### Patent Literature

Patent Literature 1: Japanese Unexamined Patent Application Publication (Translation of PCT Application) No. 2014-507631

### SUMMARY OF INVENTION

### Technical Problem

Meanwhile, in a case where the position of a living body such as a human is detected using a single radar apparatus or the like, it is conceivable that sufficient detection accuracy may not be achieved depending on the positional relationship between the living body and the radar, the size of the living body, the type of clothing worn by the living body, and the like. Therefore, there is a demand for improved detection accuracy at the time of detection of the position of a living body.

The present disclosure aims to solve the problem described above, and an object thereof is to provide an information processing apparatus, a living body detection system, and an information processing method that can improve the detection accuracy at the time of detection of the position of a living body as compared to conventional techniques.

### Solution to Problem

An information processing apparatus according to the present disclosure includes: a processor; and a memory storing a program, upon executed by the processor, to perform a process: to acquire first distance information about a distance from a first antenna to a living body and second distance information about a distance from a second antenna to the living body, the first antenna and the second antenna being arranged at mutually different positions, the first distance information and the second distance information being obtained by receiving reflection waves of electromagnetic waves, transmitted from the first antenna and the second antenna, off the living body at the first antenna and the second antenna; to reproduce a synthetic aperture image of an observation space on a basis of the first distance information acquired, the second distance information acquired, and positional information about each of the first antenna and the second antenna, and estimate a position of the living body on a basis of the synthetic aperture image; and to control a light emission mode of an illumination apparatus according to the position of the living body estimated in a plurality of illumination apparatuses on a basis of the position of the living body, wherein the process controls a light emission mode of an illumination apparatus according to the position of the living body estimated in such a manner that, on a basis of a temporal change in the position of the living body, brightness of an illumination apparatus positioned forward in relation to a moving direction of the living body in the plurality of illumination apparatuses becomes higher than brightness of an illumination apparatus positioned backward in relation to the moving direction of the living body in the plurality of illumination apparatuses.

### Advantageous Effects of Invention

According to the present disclosure, the position of a living body is estimated on the basis of the distances between a plurality of antennas having different relative positional relationships with the living body, the distances being obtained from reflection waves of electromagnetic waves transmitted from the plurality of antennas and reflected by the living body. Accordingly, the detection accuracy at the time of detection of the position of the living body can be improved.

### BRIEF DESCRIPTION OF DRAWINGS

FIG. 1 is a schematic diagram depicting the configuration of a living body detection system according to a first embodiment.

FIG. 2 is a block diagram depicting the configuration of the living body detection system according to the first embodiment.

FIG. 3 is a block diagram illustrating an example of the hardware configuration of an information processing apparatus according to the first embodiment.

FIG. 4 is a block diagram illustrating an example of the hardware configuration of the information processing apparatus according to the first embodiment.

FIG. 5 is a flowchart depicting processes performed by the information processing apparatus according to the first embodiment.

FIG. 6 is a block diagram depicting the configuration of a living body detection system according to a second embodiment.

FIG. 7 is a flowchart depicting processes performed by the information processing apparatus according to the second embodiment.

### DESCRIPTION OF EMBODIMENTS

Hereinbelow, embodiments according to the present disclosure are explained in detail with reference to the drawings.

### First Embodiment

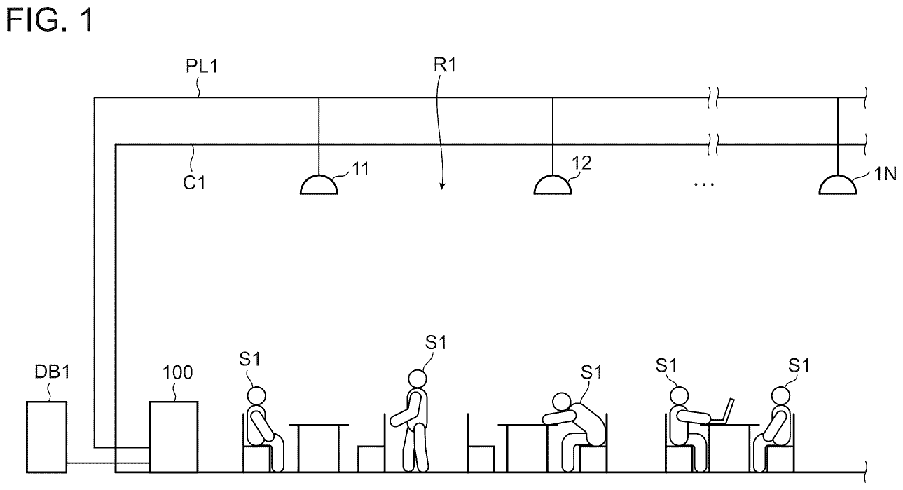

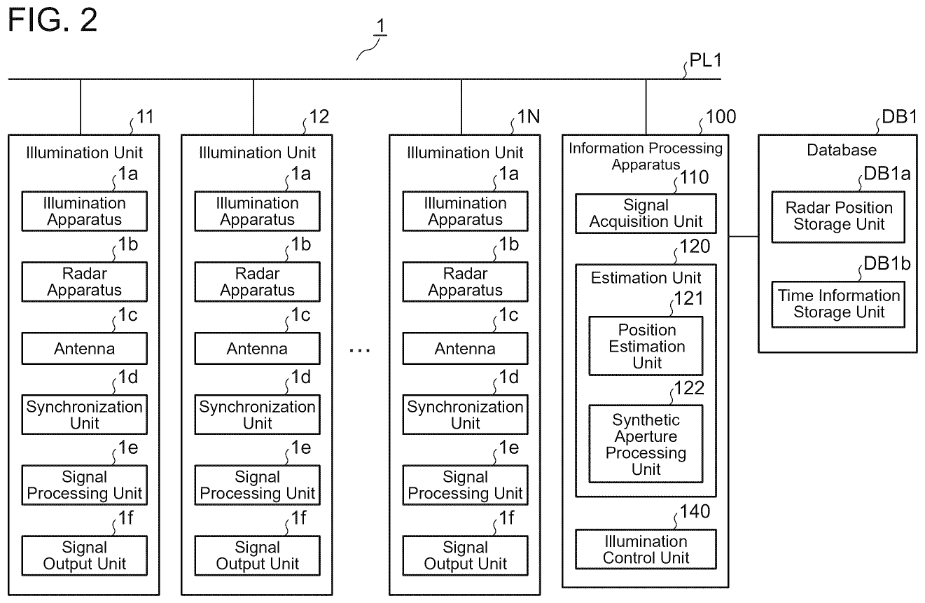

First, the configuration of a living body detection system 1 according to a first embodiment is explained with reference to FIGS. 1 and 2. FIG. 1 is a schematic diagram depicting the configuration of the living body detection system 1 according to the first embodiment, and FIG. 2 is a block diagram depicting the configuration of the living body detection system 1 according to the first embodiment. The living body detection system 1 according to the first embodiment includes: illumination units 11, 12, . . . , and 1N as a plurality of illumination units; an information processing apparatus 100, and a database DB1. The illumination units 11, 12, . . . , and 1N (N is a natural number which is two or greater) and the information processing apparatus 100 are supplied with power via a power line PL1. The living body detection system 1 is a system for detecting living bodies around the living body detection system 1. The living bodies detected by the living body detection system 1 may be any living bodies such as animals or other living bodies as long as they are moving living bodies. In an exemplary case explained hereinbelow, the living bodies in the living body detection system 1 are humans. Note that, in the first embodiment, the illumination unit 11 corresponds to a first illumination unit, and the illumination unit 12 corresponds to a second illumination unit.

In addition, it is sufficient if the living body detection system 1 includes two or more illumination units. For example, the living body detection system may include only two illumination units or may include three or more illumination units. In addition, in a case where the living body detection system includes three or more illumination units, a plurality of the illumination units may be arranged linearly at intervals, may be arranged planarly at intervals, or may be arranged three-dimensionally at intervals. In other words, in a case where the living body detection system includes the first illumination unit, the second illumination unit, and a third illumination unit, the first illumination unit, the second illumination unit, and the third illumination unit may be arranged linearly at intervals in a predetermined direction. Alternatively, the first illumination unit, the second illumination unit, and the third illumination unit may be arranged planarly in such a manner that the first illumination unit and the second illumination unit are arranged at an interval in a first direction, and the first illumination unit and the third illumination unit are arranged at an interval in a second direction different from the first direction.

Each of the illumination units 11, 12, . . . , and 1N has an illumination apparatus 1a, a radar apparatus 1b, an antenna 1c, a synchronization unit 1d, a signal processing unit 1e, and a signal output unit 1f. The illumination units 11, 12, . . . , and 1N are arranged at intervals. For example, the illumination apparatuses 1a are arranged at mutually different positions on a ceiling C1 of a room R1 in a house, a store, an office, or the like. In addition, for example, each of the illumination units 11, 12, . . . , and 1N includes the illumination apparatus 1a, the radar apparatus 1b, the antenna 1c, the synchronization unit 1d, the signal processing unit 1e, and the signal output unit 1f that can be integrally attached to and detached from the ceiling, the floor surface, the wall surface, and the like. In addition, for example, the illumination units 11, 12, . . . , and 1N have a common power supply path that supplies power to each unit of the illumination units including the illumination apparatuses 1a and the radar apparatuses 1b. In addition, the illumination units 11, 12, . . . , and 1N are communicatively connected with each other by power line communication via the power line PL1. The details of the communication performed by the illumination units 11, 12, . . . , and 1N is mentioned later.

Each illumination apparatus 1a consumes power supplied from the power line PL1 to emit light, and irradiates a predetermined irradiation range with light. For example, the illumination apparatus 1a has a light-emitting diode (LED), an incandescent lamp, or a fluorescent lamp, and irradiates the predetermined irradiation range with light downward from the ceiling C1.

Each radar apparatus 1b generates a transmission signal which is a signal for causing an electromagnetic wave to be transmitted from the antenna 1c. For example, the radar apparatus 1b has a transmitter for generating the electromagnetic wave. In addition, for example, the radar apparatus 1b generates a millimeter wave as the electromagnetic wave. Note that, in the first embodiment, the radar apparatus 1b that the illumination unit 11 has corresponds to a first radar apparatus, and the radar apparatus 1b that the illumination unit 12 has corresponds to a second radar apparatus.

Each antenna 1c externally transmits the signal generated by the radar apparatus 1b as the electromagnetic wave. For example, the antenna 1c transmits, as the electromagnetic wave, the transmission signal generated by the radar apparatus 1b toward the space inside the room R1. In addition, the antenna 1c receives a reflection wave that is generated when the transmitted electromagnetic wave is reflected by a nearby object including a person S1. Note that an object that has reflected the electromagnetic wave transmitted from the antenna 1c is also called a reflecting object in the following explanation. In addition, in the first embodiment, the antenna 1c that the illumination unit 11 has corresponds to a first antenna, and the antenna 1c that the illumination unit 12 has corresponds to a second antenna.

Each synchronization unit 1d synchronizes the operation performed by the respective radar apparatuses 1b that the illumination units 11, 12, . . . , and 1N have. For example, the synchronization unit 1d synchronizes the operation performed by the respective radar apparatuses 1b by communicating with the other synchronization units 1d via the power line PL1, and causes the respective antennas 1c that the illumination units 11, 12, . . . , and 1N have to sequentially transmit electromagnetic waves by time-division processing. Thereby, the synchronization unit 1d reduces the interference between the electromagnetic waves transmitted from the respective antennas 1c.

Each signal processing unit 1e performs a process on a reception signal which is a signal based on a reflection wave received by the antenna 1c, and acquires distance information about the distance between the antenna 1c and a reflecting object. For example, the signal processing unit 1e performs coherent processing including processing such as filtering, upsampling, or downsampling on the reception signal, and calculates, as the distance information, a distance spectrum representing the distance between the first antenna and the reflecting object. Note that, in the first embodiment, distance information about the distance between the first antenna and a reflecting object is also called first distance information, and distance information about the distance between the second antenna and a reflecting object is also called second distance information.

Each signal output unit 1f outputs distance information about the distance between the antenna 1c and a reflecting object acquired by the signal processing unit 1e to the information processing apparatus 100 via the power line PL1.

The database DB1 has a radar position storage unit DB1a and a time information storage unit DB1b, and is communicatively connected with the information processing apparatus 100. The radar position storage unit DB1a stores radar position information which is information representing the positions of the respective antennas 1c that the illumination units 11, 12, . . . , and 1N have. The time information storage unit DB1b stores time information about times. For example, the time information storage unit DB1b stores information representing the current time as the time information. In addition, for example, as the time information, the time information storage unit DB1b acquires, via the information processing apparatus 100, times at which electromagnetic waves have been transmitted from the respective antennas 1c and times at which the respective antennas 1c have received reflection waves, and stores time information about these times. Note that the database DB1 may be configured integrally with the information processing apparatus 100, or may be configured as part of the function of the information processing apparatus 100.

The information processing apparatus 100 includes a signal acquisition unit 110 as an information acquisition unit, an estimation unit 120, and an illumination control unit 140, and is communicatively connected with the illumination units 11, 12, . . . , and 1N by power line communication via the power line PL1. The signal acquisition unit 110 acquires information from the respective signal output units 1f of the illumination units 11, 12, . . . , and 1N.

The estimation unit 120 estimates the position of a person S1 who is a detection target on the basis of distance information acquired by the signal acquisition unit 110. For example, the estimation unit 120 has: a synthetic aperture processing unit 122 that forms an image of the space inside the room R1 by synthetic aperture processing on the basis of a distance spectrum representing the distances from the respective antennas 1c to a reflecting object acquired by the signal acquisition unit 110, and positional information about the respective antennas 1c acquired from the radar position storage unit DB1a; and a position estimation unit 121 that estimates the position of each person S1 who is a detection target on the basis of the image (synthetic aperture image) obtained by the synthetic aperture processing.

For example, the synthetic aperture processing unit 122 forms an image of the space inside the room R1 by synthetic aperture processing on the basis of radar position information of each antenna 1c and distance information output from the illumination units 11, 12, . . . , and 1N. In addition, on the basis of the reproduced synthetic aperture image, the position estimation unit 121 estimates that a person S1 is included in the space inside the room R1 and estimates the position and posture of the person S1 at a particular time. For example, the position estimation unit 121 estimates the position and posture of a person S1 by a trained model that outputs the shape of a reflecting object as an image in response to the input of the reproduced synthetic aperture image.

The illumination control unit 140 controls the light emission mode of each illumination apparatus 1a on the basis of a result of estimation by the position estimation unit 121. For example, the illumination control unit 140 controls the light emission mode such as luminous intensity, light color, illuminating state, and off state of each illumination apparatus 1a on the basis of a result of estimation by the position estimation unit 121. The details of the control of the illumination apparatuses 1a by the illumination control unit 140 is mentioned later.

By being configured in this manner, the living body detection system 1 functions as a synthetic aperture radar for detecting living bodies, with a plurality of the antennas 1c of the illumination units 11, 12, . . . , and 1N functioning as element antennas.

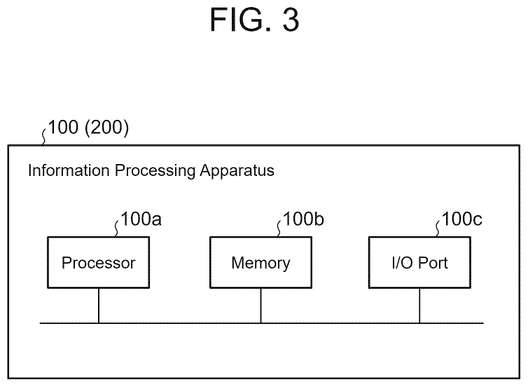

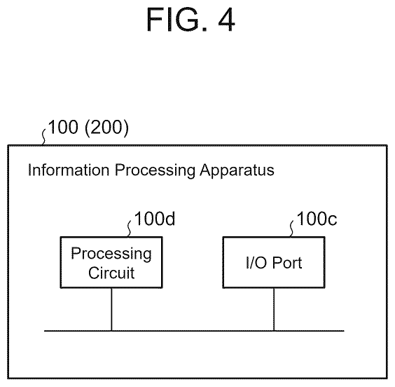

Next, the hardware configuration of the information processing apparatus 100 is explained with reference to FIGS. 3 and 4. FIG. 3 is a block diagram illustrating an example of the hardware configuration of the information processing apparatus 100 according to the first embodiment, and FIG. 4 is a block diagram illustrating an example of the hardware configuration of the information processing apparatus 100 according to the first embodiment which is different from that illustrated in FIG. 3. For example, as illustrated in FIG. 3, the information processing apparatus 100 has a processor 100a, a memory 100b, and an I/O port 100c, and is configured in such a manner that the processor 100a reads out and executes programs stored on the memory 100b. For example, the memory 100b includes a non-volatile or volatile semiconductor memory such as a RAM, a ROM, a flash memory, an EPROM, or an EEPROM or a combination of these. In addition, the memory 100b may be a magnetic disk, a flexible disc, an optical disc, a compact disc, a mini disc, a DVD, or the like. Furthermore, the memory 100b may be an HDD or an SSD.

In addition, for example, as illustrated in FIG. 4, the information processing apparatus 100 has a processing circuit 100d, which is dedicated hardware, and an I/O port 100c. For example, the processing circuit 100d includes a single circuit, a composite circuit, a programmed processor, a parallel-programmed processor, a system large-scale integration (LSI), an application specific integrated circuit (ASIC), a field programmable gate array (FPGA), or a combination of these. Respective functions of the information processing apparatus 100 are implemented by the processor 100a or the processing circuit 100d, which is dedicated hardware, executing a program which is software, firmware, or a combination of software and firmware.

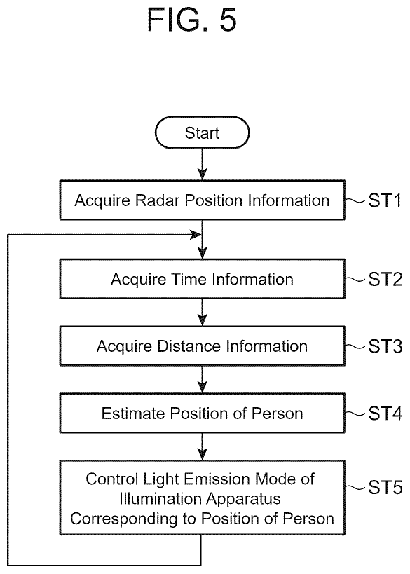

Next, details of processes performed by the information processing apparatus 100 according to the first embodiment for detecting the positions of living bodies are explained with reference to FIG. 5. FIG. 5 is a flowchart depicting processes performed by the information processing apparatus 100 according to the first embodiment. As illustrated in FIG. 5, when the processes are started, the information processing apparatus 100 acquires radar position information about each antenna 1c from the database DB1 (Step ST1).

After the process at Step ST1 is performed, the information processing apparatus 100 acquires time information from the database DB1 (Step ST2). After the process at Step ST2 is performed, the information processing apparatus 100 causes the signal acquisition unit 110 to acquire distance information from the illumination units 11, 12, . . . , and 1N (Step ST3).

After the process at Step ST3 is performed, the information processing apparatus 100 causes the estimation unit 120 to determine whether or not a person S1 is included in reflecting objects in the space inside the room R1 by reproducing a synthetic aperture image of the space inside the room R1. In a case where it is determined that a person S1 is included the reflecting objects, the information processing apparatus 100 causes the estimation unit 120 to estimate the position of the person S1 at a particular time (Step ST4).

After the process at Step ST4 is performed, the information processing apparatus 100 controls the light emission modes of the illumination apparatuses 1a of the illumination units 11, 12, . . . , and 1N on the basis of the estimated position of the person S1 (Step ST5). In other words, the information processing apparatus 100 causes the illumination control unit 140 to control the light emission mode of an illumination apparatus 1a according to the position of the person S1 in a plurality of the illumination apparatuses 1a. For example, the illumination control unit controls the light emission mode of the illumination apparatus 1a according to the position of the person S1 in the plurality of illumination apparatuses 1a in such a manner that the brightness of the illumination apparatus 1a according to the position of the living body is switched between a first state and a second state in which the brightness is different from the brightness in the first state. In addition, for example, the illumination control unit controls the light emission mode of the illumination apparatus 1a according to the position of the person S1 in the plurality of illumination apparatuses 1a in such a manner that the illumination apparatus 1a according to the position of the living body is switched among an illuminating state in which the illumination apparatus 1a is turned on, a blinking state in which the illumination apparatus 1a is blinking, and an off state in which the illumination apparatus 1a is turned off.

For example, the information processing apparatus 100 controls the light emission modes of a plurality of illumination apparatuses 1a in such a manner that an illumination apparatus 1a closest to the position of a particular person S1 in the plurality of illumination apparatuses 1a is turned on, and some or all of illumination apparatuses 1a including an illumination apparatus 1a farthest from the position of the particular person S1 in the other illumination apparatuses 1a are turned off.

In addition, for example, in a case where it has been estimated by the estimation unit 120 that reflecting objects include a plurality of persons S1, the information processing apparatus 100 controls the light emission modes of a plurality of illumination apparatuses 1a in such a manner that an illumination apparatus 1a closest to the position of each person S1 in the plurality of illumination apparatuses 1a is turned on, and illumination apparatuses 1a whose distances from all the persons S1 are equal to or greater than a preset distance in the other illumination apparatuses 1a are turned off.

In addition, for example, the information processing apparatus 100 controls the light emission modes of a plurality of illumination apparatuses 1a in such a manner that an illumination apparatus 1a whose irradiation range is closest to the position of a particular person S1 in the plurality of illumination apparatuses 1a is turned on, and some or all of illumination apparatuses 1a including an illumination apparatus 1a whose irradiation range is farthest from the position of the particular person S1 in the other illumination apparatuses 1a are turned off.

In addition, for example, in a case where it has been estimated by the estimation unit 120 that reflecting objects include a plurality of persons S1, the information processing apparatus 100 controls the light emission modes of a plurality of illumination apparatuses 1a in such a manner that an illumination apparatus 1a whose irradiation range is closest to the position of each person S1 in the plurality of illumination apparatuses 1a is turned on, and illumination apparatuses 1a whose irradiation ranges from all the persons S1 are equal to or greater than a preset distance in the other illumination apparatuses 1a are turned off.

Note that, instead of turning off illumination apparatuses 1a whose distances are equal to or greater than a preset distance, the information processing apparatus 100 may be configured to control the light emission modes of a plurality of illumination apparatuses 1a in such a manner that illumination apparatuses 1a that are apart by a preset number of illumination apparatuses 1a or more are turned off.

In addition, for example, the information processing apparatus 100 causes the illumination control unit 140 to estimate the moving direction of each person S1 on the basis of temporal changes in the position of the person S1, and, on the basis of the position and moving direction of a particular person S1, controls the light emission modes of a plurality of illumination apparatuses 1a in such a manner that the brightness of an illumination apparatus 1a positioned forward in relation to the moving direction of the particular person S1 in the plurality of illumination apparatuses 1a becomes higher than the brightness of any illumination apparatus 1a positioned backward in relation to the moving direction of the particular person S1 in the plurality of illumination apparatuses 1a.

Specifically, the information processing apparatus 100 causes the illumination control unit 140 to estimate the moving direction of each person S1 on the basis of temporal changes in the position of the person S1, and, on the basis of the position and moving direction of a particular person S1, controls the light emission modes of a plurality of illumination apparatuses 1a in such a manner that the brightness of an illumination apparatus 1a that is positioned forward in relation to the moving direction of the particular person S1 and whose position is at a distance from the particular person S1 which is equal to or shorter than a preset distance in the plurality of illumination apparatuses 1a is higher than the brightness of illumination apparatuses 1a that are positioned backward in relation to the moving direction of the particular person S1 and whose positions are at distances which are equal to or greater than the preset distance in the plurality of illumination apparatuses 1a.

In addition, for example, the information processing apparatus 100 causes the illumination control unit 140 to estimate the moving direction of each person S1 on the basis of temporal changes in the position of the person S1, and, on the basis of the position and moving direction of a particular person S1, controls the light emission modes of a plurality of illumination apparatuses 1a in such a manner that an illumination apparatus 1a positioned forward in relation to the moving direction of the particular person S1 in the plurality of illumination apparatuses 1a is turned on, and any illumination apparatus 1a positioned backward in relation to the moving direction of the particular person S1 in the plurality of illumination apparatuses 1a is turned off.

In addition, for example, the information processing apparatus 100 causes the illumination control unit 140 to estimate the moving direction of each person S1 on the basis of temporal changes in the position of the person S1, and, on the basis of the position and moving direction of a particular person S1, controls the brightness of a plurality of illumination apparatuses 1a in such a manner that the brightness of an illumination apparatus 1a closest to the position of the particular person S1 and an illumination apparatus 1a positioned forward in relation to the moving direction of the particular person S1 in the plurality of illumination apparatuses 1a becomes higher than the brightness of any illumination apparatus 1a positioned backward in relation to the moving direction of the particular person S1 in the plurality of illumination apparatuses 1a.

In addition, for example, the information processing apparatus 100 causes the illumination control unit 140 to estimate the moving direction and movement speed of each person S1 on the basis of temporal changes in the position of the person S1, and, on the basis of the position, moving direction, and movement speed of a particular person S1, control the light emission modes of a plurality of illumination apparatuses 1a in such a manner that the brightness of an illumination apparatus 1a that is positioned forward in relation to the moving direction of the particular person S1 and whose distance from the particular person S1 will become equal to or shorter than a preset distance in preset time in the plurality of illumination apparatuses 1a becomes higher than the brightness of illumination apparatuses 1a that are positioned backward in relation to the moving direction of the particular person S1 and whose distances from the particular person S1 have been equal to or greater than the preset distance for preset time or longer in the plurality of illumination apparatuses 1a.

In addition, for example, the information processing apparatus 100 causes the illumination control unit 140 to estimate the moving direction of each person S1 on the basis of temporal changes in the position of the person S1, and, on the basis of the position and moving direction of a particular person S1, controls the brightness of a plurality of illumination apparatuses 1a in such a manner that the brightness of an illumination apparatus 1a whose irradiation range is closest to the position of the particular person S1 and an illumination apparatus 1a whose irradiation range is positioned forward in relation to the moving direction of the particular person S1 in the plurality of illumination apparatuses 1a becomes higher than the brightness of any illumination apparatus 1a whose irradiation range is positioned backward in relation to the moving direction of the particular person S1 in the plurality of illumination apparatuses 1a.

In addition, for example, the information processing apparatus 100 causes the illumination control unit 140 to estimate the moving direction and movement speed of each person S1 on the basis of temporal changes in the position of the person S1, and, on the basis of the position, moving direction, and movement speed of a particular person S1, control the light emission modes of a plurality of illumination apparatuses 1a in such a manner that the brightness of an illumination apparatus 1a that is positioned forward in relation to the moving direction of the particular person S1 and whose irradiation range will cover the particular person S1 in preset time in the plurality of illumination apparatuses 1a becomes higher than the brightness of illumination apparatuses 1a that are positioned backward in relation to the moving direction of the particular person S1 and whose irradiation ranges have not covered the particular person S1 for preset time or longer in the plurality of illumination apparatuses 1a.

Note that the respective controls of the light emission modes of illumination apparatuses 1a performed by the information processing apparatus 100 mentioned above can be combined with each other in any manner or any control can be omitted.

After the process at Step ST5 is performed, the information processing apparatus 100 returns to the process at Step ST2, and repeats the processes at Steps ST2 to ST5.

As mentioned above, the living body detection system 1 according to the first embodiment includes the information processing apparatus including: the information acquisition unit to acquire the first distance information about the distance from the first antenna to a living body and the second distance information about the distance from the second antenna to the living body, the first antenna and the second antenna being arranged at mutually different positions, the first distance information and the second distance information being obtained by receiving reflection waves of electromagnetic waves, transmitted from the first antenna and the second antenna, off the living body at the first antenna and the second antenna; and the estimation unit to estimate the position of the living body on the basis of the first distance information acquired by the information acquisition unit and the second distance information acquired by the information acquisition unit.

Thereby, the living body detection system 1 estimates the position of the living body from a synthetic aperture image based on the distances between the plurality of antennas and the living body obtained from the reflection waves of the electromagnetic waves, transmitted from the plurality of antennas, off the living body. Accordingly, the detection accuracy at the time of detection of the position of the living body can be improved than in a case where the position of the living body is estimated on the basis of the distance between a single antenna and the living body.

In addition, the information processing apparatus 100 according to the first embodiment includes the illumination control unit to control the light emission mode of an illumination apparatus according to the position of the living body estimated by the estimation unit in the plurality of illumination apparatuses including the first illumination apparatus and the second illumination apparatus on the basis of the position of the living body. Thereby, for example, it becomes possible for the living body detection system 1 according to the first embodiment to lower the brightness of an illumination apparatus whose importance is relatively low according to the position of the living body, and to reduce the power consumption of the illumination apparatus.

Note that, in the living body detection system 1 according to the first embodiment, the illumination units 11, 12, . . . , and 1N and the information processing apparatus 100 are communicatively connected with each other by power line communication via the power line PL1, and the signal acquisition unit 110 acquires distance information from each illumination unit via the power line communication. Thereby, in the living body detection system 1, the relocation, addition, and removal of the illumination units 11, 12, . . . , and 1N become easier, and it becomes possible to reduce the work load for the relocation, addition, or removal of the illumination units 11, 12, . . . , and 1N.

Note that whereas the illumination units 11, 12, . . . , and 1N and the information processing apparatus 100 are communicatively connected with each other by power line communication via the power line PL1 in the living body detection system 1 according to the first embodiment, this is not the sole example. For example, the plurality of illumination units may be or the plurality of illumination units and the information processing apparatus may be communicatively connected with each other by wireless communication in the living body detection system. For example, in a case where the living body detection system is configured in this manner, by communicatively connecting the plurality of illumination units and communicatively connecting the plurality of illumination units and the information processing apparatus with each other by OFDM radar communication, and encoding and transmitting a signal for synchronization among the plurality of illumination units and a past (previous) reception signal in an OFDM radar signal transmitted from an antenna for monitoring the surroundings, it becomes possible to shorten the monitoring intervals compared to the transmission of signals such as a synchronization signal, an OFDM radar signal, and the like at different times.

### Second Embodiment

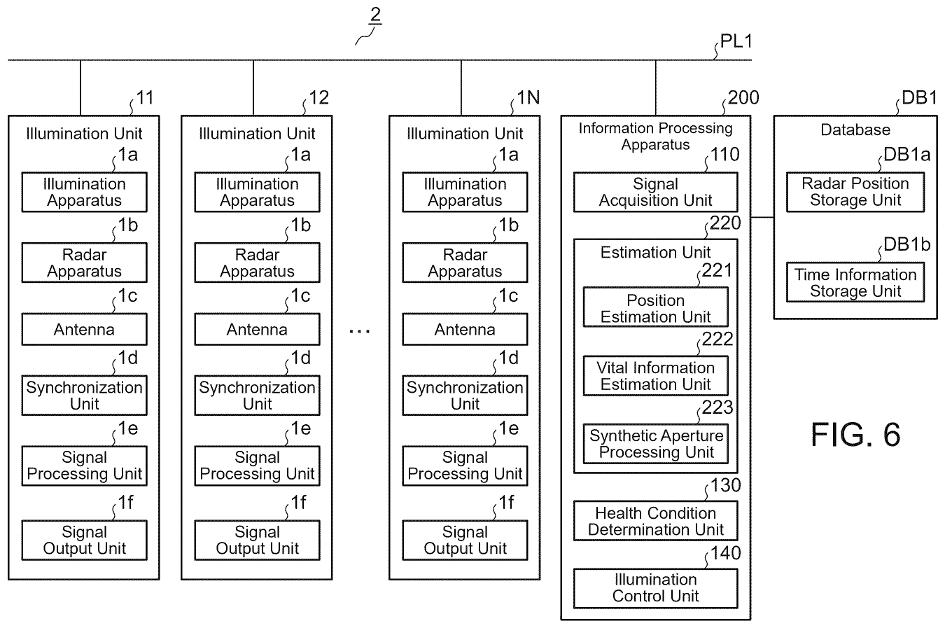

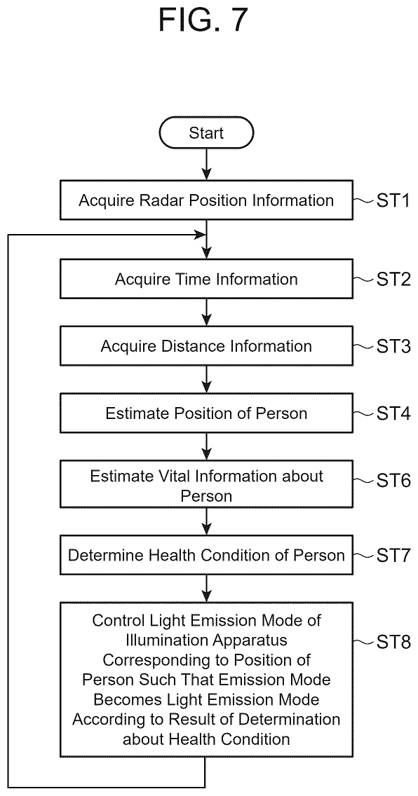

Next, a living body detection system 2 according to a second embodiment is explained with reference to FIGS. 6 and 7. As compared to the living body detection system 1 according to the first embodiment, the living body detection system 2 according to the second embodiment is configured differently in that an information processing apparatus estimates vital information about living bodies in addition to the positions of the living bodies, and controls illumination apparatuses 1a on the basis of the estimated positions of the living bodies and the estimated vital information about the living bodies, but the other configurations of the living body detection system 2 according to the second embodiment are the same as those of the living body detection system 1 according to the first embodiment. The same configurations as the first embodiment are given identical reference signs, and explanations thereof are omitted.

FIG. 6 is a block diagram depicting the configuration of the living body detection system 2 according to the second embodiment. The living body detection system 2 according to the second embodiment includes illumination units 11, 12, . . . , and 1N as a plurality of illumination units, an information processing apparatus 200, and a database DB1. The information processing apparatus 200 includes a signal acquisition unit 110, an estimation unit 220, a health condition determination unit 130, and an illumination control unit 140, and is communicatively connected with the illumination units 11, 12, . . . , and 1N by power line communication via a power line PL1.

The estimation unit 220 has a position estimation unit 221, a vital information estimation unit 222, and a synthetic aperture processing unit 223. The vital information estimation unit 222 estimates vital information about a person S1 included in reflecting objects on the basis of a result of estimation by a position estimation unit 121. The vital information estimation unit 222 estimates vital information about a particular person S1 on the basis of a result of estimation of temporal changes in the shape of the person S1 by the position estimation unit 121. In other words, the vital information estimation unit 222 estimates vital information about a person S1 included in reflecting objects on the basis of temporal changes in distance information acquired by the signal acquisition unit 110. For example, the vital information estimation unit 222 estimates vital information such as pulse, heartbeat, respiratory rate, and blood pressure of a particular person S1 on the basis of temporal changes in the shape of the particular person S1. For example, the vital information estimation unit 222 estimates vital information about each person S1 included in reflecting objects on the basis of micro-Doppler information generated by the person S1 using the input of radar position information and distance information. Since processes performed by the synthetic aperture processing unit 223 are the same as the processes performed by the synthetic aperture processing unit 122 according to the first embodiment, explanations thereof are omitted.

The health condition determination unit 130 estimates the health condition of each person S1 on the basis of a result of estimation by the vital information estimation unit 222. For example, the health condition determination unit 130 determines the health condition of each person S1 as to whether or not the person S1 is in a sleeping state, whether or not the person S1 is in a support required state in which the person S1 requires support including medical intervention, and so on as the health condition of the person S1 on the basis of the pulse, heartbeat, respiratory rate, blood pressure, and the like of the person S1 estimated by the vital information estimation unit 222. For example, the health condition determination unit 130 determines the health condition of each person S1 on the basis of whether or not vital information about the person S1 estimated by the vital information estimation unit 222 falls within preset thresholds. Note that the information processing apparatus 200 may be configured to estimate the health condition of each person S1 using a trained model that outputs the health condition of the person S1 in response to the input of radar position information and distance information.

The illumination control unit 140 according to the second embodiment controls the light emission mode of each illumination apparatus 1a on the basis of a result of estimation by the position estimation unit 221 and a result of determination by the health condition determination unit 130. For example, the illumination control unit 140 controls the light emission mode such as luminous intensity, light color, switching between the illuminating state and the off state, and irradiation range of each illumination apparatus 1a on the basis of a result of estimation by the position estimation unit 221 and a result of determination by the health condition determination unit 130. Note that since the health condition determination unit 130 determines the health condition of a person S1 on the basis of vital information about the person S1 estimated by the vital information estimation unit 222, it can be said that the illumination control unit 140 controls the light emission mode of each illumination apparatus 1a on the basis of a result of estimation by the position estimation unit 221 and a result of estimation by the vital information estimation unit 222. The details of the control of the illumination apparatuses 1a by the illumination control unit 140 according to the second embodiment is mentioned later.

Since the hardware configuration of the information processing apparatus 200 according to the second embodiment is the same as the hardware configuration of the information processing apparatus 100 according to the first embodiment, explanations thereof are omitted.

FIG. 7 is a flowchart depicting processes performed by the information processing apparatus 200 according to the second embodiment. In the processes performed by the information processing apparatus 200, processes at Step ST1 to Step ST4 are the same processes as the processes performed by the information processing apparatus 100 according to the first embodiment. Accordingly, explanations thereof are omitted.

After the process at Step ST4 is performed, the information processing apparatus 200 causes the vital information estimation unit 222 to estimate vital information about a person S1 included in reflecting objects (Step ST6). After the process at Step ST6 is performed, the information processing apparatus 200 causes the health condition determination unit 130 to determine the health condition of the person S1 included in the reflecting objects (Step ST7).

After the process at Step ST7 is performed, the information processing apparatus 200 controls the light emission modes of the illumination apparatuses 1a of the illumination units 11, 12, . . . , and 1N on the basis of the estimated position and determined health condition of the person S1 (Step ST8). In other words, the information processing apparatus 100 causes the illumination control unit 140 to control the light emission mode of an illumination apparatus 1a according to the position of the person S1 in a plurality of the illumination apparatuses 1a in such a manner that the light emission mode of the illumination apparatus 1a becomes a light emission mode according to the health condition of the person S1.

For example, in a case where a particular person S1 is in a sleeping state, the information processing apparatus 100 controls the light emission mode of an illumination apparatus 1a closest to the position of the particular person S1 in the plurality of illumination apparatuses 1a in such a manner that the brightness of the illumination apparatus 1a is made darker than in a case where the particular person S1 is not in a sleeping state.

In addition, for example, in a case where a particular person S1 is in a sleeping state, the information processing apparatus 100 controls the light emission mode of an illumination apparatus 1a whose irradiation range is closest to the position of the particular person S1 in the plurality of illumination apparatuses 1a in such a manner that the brightness of the illumination apparatus 1a is made darker than in a case where the particular person S1 is not in a sleeping state. By being configured in this manner, it becomes possible for the living body detection system 2 according to the second embodiment to improve the sleep quality of the person S1 in a sleeping state, and to reduce the power consumption by the illumination apparatus 1a.

In addition, for example, the information processing apparatus 100 controls the light emission mode of an illumination apparatus 1a closest to the position of a particular person S1 in the plurality of illumination apparatuses 1a in such a manner that the illumination apparatus 1a is turned on in a case where the particular person S1 is not in a support required state, and is caused to blink in a case where the particular person S1 is in a support required state. Note that the information processing apparatus 100 may be configured to cause an illumination apparatus 1a to blink at a light color different from a color that is used when the illumination apparatus 1a is in an illuminating state, in a case where the illumination apparatus 1a is caused to blink according to the health condition of a particular person S1. For example, the information processing apparatus 100 may be configured to control an illumination apparatus 1a in such a manner that, on the basis of the health condition of a particular person S1, the light color of the illumination apparatus 1a in a blinking state is red or yellow, and the light color of the illumination apparatus 1a in an illuminating state is white or a warm color close to white. By being configured in this manner, it becomes possible for the living body detection system 2 according to the second embodiment to inform people nearby that the particular person S1 is in a support required state.

Note that the present disclosure allows any combination of the respective embodiments, modification of any component in the respective embodiments, or omission of any component in the respective embodiments.

### INDUSTRIAL APPLICABILITY

For example, an information processing apparatus according to the present disclosure can be used to estimate the position of a person in a room.

Hereinbelow, several aspects of the present disclosure are summarized as supplementary notes.

### Supplementary Note 1

An information processing apparatus including:
an information acquisition unit to acquire first distance information about a distance from a first antenna to a living body and second distance information about a distance from a second antenna to the living body, the first antenna and the second antenna being arranged at mutually different positions, the first distance information and the second distance information being obtained by receiving reflection waves of electromagnetic waves, transmitted from the first antenna and the second antenna, off the living body at the first antenna and the second antenna; and
an estimation unit to reproduce a synthetic aperture image of an observation space on a basis of the first distance information acquired by the information acquisition unit, the second distance information acquired by the information acquisition unit, and positional information about each of the first antenna and the second antenna, and estimate a position of the living body on a basis of the synthetic aperture image.

### Supplementary Note 2

The information processing apparatus according to supplementary note 1, including an illumination control unit to control a light emission mode of an illumination apparatus according to the position of the living body estimated by the estimation unit in a plurality of illumination apparatuses on a basis of the position of the living body.

### Supplementary Note 3

The information processing apparatus according to supplementary note 1 or 2, in which the illumination control unit controls a light emission mode of an illumination apparatus according to the position of the living body estimated by the estimation unit in such a manner that, on a basis of the position of the living body, brightness of an illumination apparatus whose irradiation range is closest to the position of the living body in the plurality of illumination apparatuses is switched between a first state and a second state in which the brightness is different from the brightness in the first state.

### Supplementary Note 4

The information processing apparatus according to any one of supplementary notes 1 to 3, in which the illumination control unit controls a light emission mode of an illumination apparatus according to the position of the living body estimated by the estimation unit in such a manner that, on a basis of a temporal change in the position of the living body, brightness of an illumination apparatus positioned forward in relation to a moving direction of the living body in the plurality of illumination apparatuses becomes higher than brightness of an illumination apparatus positioned backward in relation to the moving direction of the living body in the plurality of illumination apparatuses.

### Supplementary Note 5

The information processing apparatus according to any one of supplementary notes 1 to 4, in which the estimation unit estimates vital information about the living body on a basis of a change in the first distance information and the second distance information acquired by the information acquisition unit.

### Supplementary Note 6

The information processing apparatus according to any one of supplementary notes 1 to 5, in which the illumination control unit controls a light emission mode of an illumination apparatus according to the position of living body estimated by the estimation unit on a basis of the position of the living body and the vital information about the living body estimated by the estimation unit.

### Supplementary Note 7

The information processing apparatus according to any one of supplementary notes 1 to 6, in which the illumination control unit determines whether or not the living body is sleeping on a basis of the vital information about the living body estimated by the estimation unit, and, in a case where it is determined that the living body is sleeping, controls a light emission mode of an illumination apparatus according to the position of the living body estimated by the estimation unit in such a manner that, on a basis of the position of the living body, brightness of an illumination apparatus whose irradiation range is closest to the position of the living body in the plurality of illumination apparatuses becomes lower than the brightness of the illumination apparatus in a case where it is determined that the living body is not sleeping.

### Supplementary Note 8

The information processing apparatus according to any one of supplementary notes 1 to 7, in which the illumination control unit performs control in such a manner that a light emission mode of an illumination apparatus according to the position of the living body estimated by the estimation unit is switched between an illuminating state and a blinking state on a basis of the position of the living body and the vital information about the living body estimated by the estimation unit.

### Supplementary Note 9

The information processing apparatus according to any one of supplementary notes 1 to 8, in which the information acquisition unit acquires the first distance information and the second distance information via power line communication.

### Supplementary Note 10

The information processing apparatus according to any one of supplementary notes 1 to 9, in which the information acquisition unit acquires the first distance information and the second distance information via wireless communication.

### Supplementary Note 11

A living body detection system, in which
the plurality of illumination apparatuses include a first illumination apparatus and a second illumination apparatus, and
the living body detection system includes:
   the information processing apparatus according to any one of supplementary notes 1 to 10;
   a first illumination unit having: the first illumination apparatus; the first antenna; and a first radar apparatus to generate a signal for causing an electromagnetic wave to be transmitted from the first antenna; and
a second illumination unit having: the second illumination apparatus; the second antenna; and a second radar apparatus to generate a signal for causing an electromagnetic wave to be transmitted from the second antenna.

### Supplementary Note 12

The living body detection system according to supplementary note 11, in which the first radar apparatus and the first illumination apparatus are supplied with power via a common power supply path that the first illumination unit has.

### Supplementary Note 13

An information processing method performed by an apparatus including an information acquisition unit and an estimation unit, the information processing method including:
a step performed by the information acquisition unit to acquire first distance information about a distance from a first antenna to a living body and second distance information about a distance from a second antenna to the living body, the first antenna and the second antenna being arranged at mutually different positions, the first distance information and the second distance information being obtained by receiving reflection waves of electromagnetic waves, transmitted from the first antenna and the second antenna, off the living body at the first antenna and the second antenna; and
a step performed by the estimation unit to reproduce a synthetic aperture image of an observation space on a basis of the first distance information acquired by the information acquisition unit, the second distance information acquired by the information acquisition unit, and positional information about each of the first antenna and the second antenna, and estimate a position of the living body on a basis of the synthetic aperture image.

### REFERENCE SIGNS LIST

1: Living body detection system; 1a: Illumination apparatus (first illumination apparatus; second illumination apparatus); 1b: Radar apparatus; 1c: Antenna (first antenna; second antenna); 1d: Synchronization unit; 1e: Signal processing unit; 1f: Signal output unit (information output unit); 2: Living body detection system; 11: Illumination unit (first illumination unit); 12: Illumination unit (second illumination unit); 1N: Illumination unit; 100: Information processing apparatus; 110: Signal acquisition unit (information acquisition unit); 120: Estimation unit; 121: Position estimation unit; 122: Synthetic aperture processing unit; 130: Health condition determination unit; 140: Illumination control unit; 200: Information processing apparatus; 220: Estimation unit; 221: Position estimation unit; 222: Vital information estimation unit; 223: Synthetic aperture processing unit; C1: Ceiling; DB1: Database; DB 1a: Radar position storage unit; DB 1b: Time information storage unit; PL 1: Power line; R1: Room; S1: Person

1. An information processing apparatus comprising:
a processor; and
a memory storing a program, upon executed by the processor, to perform a process:
to acquire first distance information about a distance from a first antenna to a living body and second distance information about a distance from a second antenna to the living body, the first antenna and the second antenna being arranged at mutually different positions, the first distance information and the second distance information being obtained by receiving reflection waves of electromagnetic waves, transmitted from the first antenna and the second antenna, off the living body at the first antenna and the second antenna;
to reproduce a synthetic aperture image of an observation space on a basis of the first distance information acquired, the second distance information acquired, and positional information about each of the first antenna and the second antenna, and estimate a position of the living body on a basis of the synthetic aperture image; and
to control a light emission mode of an illumination apparatus according to the position of the living body estimated in a plurality of illumination apparatuses on a basis of the position of the living body, wherein the process controls a light emission mode of an illumination apparatus according to the position of the living body estimated in such a manner that, on a basis of a temporal change in the position of the living body, brightness of an illumination apparatus positioned forward in relation to a moving direction of the living body in the plurality of illumination apparatuses becomes higher than brightness of an illumination apparatus positioned backward in relation to the moving direction of the living body in the plurality of illumination apparatuses.

2. An information processing apparatus comprising:
a processor; and
a memory storing a program, upon executed by the processor, to perform a process:
to acquire first distance information about a distance from a first antenna to a living body and second distance information about a distance from a second antenna to the living body, the first antenna and the second antenna being arranged at mutually different positions, the first distance information and the second distance information being obtained by receiving reflection waves of electromagnetic waves, transmitted from the first antenna and the second antenna, off the living body at the first antenna and the second antenna;
to reproduce a synthetic aperture image of an observation space on a basis of the first distance information acquired, the second distance information acquired, and positional information about each of the first antenna and the second antenna, and estimate a position of the living body on a basis of the synthetic aperture image; and
to control a light emission mode of an illumination apparatus according to the position of the living body estimated in a plurality of illumination apparatuses on a basis of the position of the living body, wherein the process estimates vital information about the living body on a basis of a change in the first distance information and the second distance information acquired, wherein the process controls a light emission mode of an illumination apparatus so as to be switched between an illuminating state and a blinking state according to the position of living body estimated on a basis of the position of the living body and the vital information about the living body estimated.

3. The information processing apparatus according to claim 1, wherein the process controls a light emission mode of an illumination apparatus according to the position of the living body estimated in such a manner that, on a basis of the position of the living body, brightness of an illumination apparatus whose irradiation range is closest to the position of the living body in the plurality of illumination apparatuses is switched between a first state and a second state in which the brightness is different from the brightness in the first state.

4. The information processing apparatus according to claim 2, wherein the process determines whether or not the living body is sleeping on a basis of the vital information about the living body estimated, and, in a case where it is determined that the living body is sleeping, controls a light emission mode of an illumination apparatus according to the position of the living body estimated in such a manner that, on a basis of the position of the living body, brightness of an illumination apparatus whose irradiation range is closest to the position of the living body in the plurality of illumination apparatuses becomes lower than the brightness of the illumination apparatus in a case where it is determined that the living body is not sleeping.

5. The information processing apparatus according to claim 1, wherein the process acquires the first distance information and the second distance information via power line communication.

6. The information processing apparatus according to claim 1, wherein the process acquires the first distance information and the second distance information via wireless communication.

7. A living body detection system, wherein
the plurality of illumination apparatuses include a first illumination apparatus and a second illumination apparatus, and
the living body detection system comprises:
the information processing apparatus according to claim 1;
a first illuminator having: the first illumination apparatus; the first antenna; and a first radar apparatus to generate a signal for causing an electromagnetic wave to be transmitted from the first antenna; and
a second illuminator having: the second illumination apparatus; the second antenna; and a second radar apparatus to generate a signal for causing an electromagnetic wave to be transmitted from the second antenna.

8. The living body detection system according to claim 7, wherein the first radar apparatus and the first illumination apparatus are supplied with power via a common power supply path that the first illuminator has.

9. An information processing method comprising:
acquiring first distance information about a distance from a first antenna to a living body and second distance information about a distance from a second antenna to the living body, the first antenna and the second antenna being arranged at mutually different positions, the first distance information and the second distance information being obtained by receiving reflection waves of electromagnetic waves, transmitted from the first antenna and the second antenna, off the living body at the first antenna and the second antenna;
reproducing a synthetic aperture image of an observation space on a basis of the first distance information acquired, the second distance information acquired, and positional information about each of the first antenna and the second antenna, and estimating a position of the living body on a basis of the synthetic aperture image; and
controlling a light emission mode of an illumination apparatus according to the position of the living body estimated in a plurality of illumination apparatuses on a basis of the position of the living body, wherein the process controls a light emission mode of an illumination apparatus according to the position of the living body estimated in such a manner that, on a basis of a temporal change in the position of the living body, brightness of an illumination apparatus positioned forward in relation to a moving direction of the living body in the plurality of illumination apparatuses becomes higher than brightness of an illumination apparatus positioned backward in relation to the moving direction of the living body in the plurality of illumination apparatuses.

10. An information processing method comprising:
acquiring first distance information about a distance from a first antenna to a living body and second distance information about a distance from a second antenna to the living body, the first antenna and the second antenna being arranged at mutually different positions, the first distance information and the second distance information being obtained by receiving reflection waves of electromagnetic waves, transmitted from the first antenna and the second antenna, off the living body at the first antenna and the second antenna;
reproducing a synthetic aperture image of an observation space on a basis of the first distance information acquired, the second distance information acquired, and positional information about each of the first antenna and the second antenna, and estimating a position of the living body on a basis of the synthetic aperture image; and
controlling a light emission mode of an illumination apparatus according to the position of the living body estimated in a plurality of illumination apparatuses on a basis of the position of the living body, wherein the process estimates vital information about the living body on a basis of a change in the first distance information and the second distance information acquired, wherein the process controls a light emission mode of an illumination apparatus so as to be switched between an illuminating state and a blinking state according to the position of living body estimated on a basis of the position of the living body and the vital information about the living body estimated.
